(19) United States
(12) Patent Application Publication
(10) Pub. No.: US 2012/0319411 A1
(43) Pub. Date: Dec. 20, 2012

(54) CABINET LATCH

(76) Inventor: Matthias Müller, Wahlbach (FR)

(21) Appl. No.: 13/512,777

(22) PCT Filed: Nov. 30, 2010
(86) PCT No.: PCT/EP2010/068513

§ 371 Date: Sep. 6, 2012

Related U.S. Application Data
(60) Provisional application No. 61/265,266, filed on Nov. 30, 2009.

(51) Int. Cl. E05C 1/08; E05C 1/10

(52) U.S. Cl. 292/41; 292/33; 292/42

(57) ABSTRACT

The disclosure is directed to a multi-point latch system (1) including an operating unit (2) with at least two independently operatable operating means (3.1, 3.2). Each operating means (3.1, 3.2) is interconnected to at least two locking means (4.1, 4.2) arranged adjacent to each other. Said locking means defining locking points (5) individually activatable by said operating means.

### FIELD OF THE INVENTION

The present invention is directed to an improved cabinet latch for airplane interiors.

### BACKGROUND OF THE INVENTION

Doors of airplane cabinets often require several independent locking systems for safety reasons. The locks are identified as primary lock and a secondary lock. In case one system fails the other locking system has to be capable to hold the door closed. The secondary lock is often a simple latch-type. An additional problem is that most of the latches known today are visible on the inside of the doors. In high quality interior this is not acceptable.

In the specifications (such as FAR Sec. 25.787) relevant for airplanes, several requirements must be fulfilled for stowage compartments: Each compartment for the stowage of cargo, baggage, carry-on articles, and equipment (such as life rafts), and any other stowage compartment must be designed for its placarded maximum weight of contents and for the critical load distribution at the appropriate maximum load factors corresponding to the specified flight and ground load conditions, and to the emergency landing conditions ( . . . ). There must be a means to prevent the contents in the compartments from becoming a hazard by shifting, under the loads specified.

From Häfele (www.haefele.com) several push-lock-latches are known, which are often used for caravan interiors. These latches are relatively bulky and have the disadvantage of sticking out on the rear side of the door.

From Sealth Aero Marine (www.sealth.com) a dual bolt latch assembly is known which comprises two independent bolt and lift handles. One problem of said mechanism is the difficult and time consuming mounting and installation of said mechanism. A further problem is the difficulty in repairing said mechanisms. Although the paddle latch does not stick out on the backside of the door and the rods are hidden inside the door plate, the locking device and access plates are visible.

### Problem to be Solved

It is an object of the present invention to provide an improved latch mechanism, which avoids the problems known from the prior art. It is a further object of the invention to provide a latch mechanism, which may be installed invisible (hidden) on the inside of a door. It is still a further object of the invention to provide a latch mechanism, which is easy to operate and repair.

### SUMMARY OF THE INVENTION

In one embodiment, the invention provides a system for a latch mechanism with a primary and a secondary latch, which may be operated individually, still guaranteeing maximum safety in the case one of the latch mechanism fails. Both latches may be of a multi-point type, offering improved safety compared to the solutions known from prior art. Each of the primary and secondary latch is foreseen to provide the full functionality and load carrying capability required such that failure of one latch does not endanger the functionality of the overall system in an unwanted manner.

An embodiment of the invention is directed to a high monument latch. The newly developed high monument latch addresses increased customer awareness about design finesse and simplicity. This push-pull operated latch may be fully integrated into the door panel, providing an elegant and luxurious design that focuses on decorative elements rather than mechanics. The latch assembly integrates primary and secondary functions to comply with aviation safety regulations. This co-located function allows for easier, one-step operation rather than tedious operation of separate primary and secondary functions. The resulting elimination of distinct secondary latch locations further improves the overall aesthetical appearance. Besides the customer related benefits, the new product allows easier installation during production of doors and keeps costs down by providing a flexible, modular approach to highly customized design requirements. As a result, the newly developed latch will increase customer satisfaction, while improving cost efficiency.

The latch system in general comprises an operating unit with several individually activatable operating means such as paddles, cranks, knobs or buttons to operate the latch. Each of the individual operating means is functionally interconnected with at least one locking unit (locking means), which is normally arranged remotely to the operating unit. In difference to the prior art, the latch system offers the opportunity to easily pilot several locking points by the primary and/or secondary latch and to operate them individually via a single integrated system.

One problem which occurs, is to fulfill the specified safety requirements on one hand and to provide a solution, which can easily be mounted and which still offers high flexibility to suit several needs on the other hand. Therefore, the latch system may comprise standardized elements, which may be interconnected to each other via standardized interfaces. The latch system normally comprises an operating, a locking and a transmitting unit, which are interconnected to each other via standardized interfaces. If appropriate, the locking and the transmitting unit may be integrated with each other and form a single unit.

In an embodiment of the invention the multi-point latch system comprises an operating unit with at least two independently operatable operating means and at least two locking means arranged adjacent to each other. Each locking means is interconnected to one of said operating means. The locking means are defining locking points individually activatable by said operating means to securely lock a door by two independent locking systems integrated to each other. The operating unit and the locking unit may each comprise a housing designed to be integrated into the inside of a door. The housing of the operating unit and the housing of the locking unit may comprise standardized interfaces, compatible to each other to interconnect the operating unit and the locking unit. In an embodiment the locking unit comprises two connecting rods arranged adjacent to each other, each connecting rod actuating an individual locking point. Depending on the field of application the operating unit and the locking may be interconnected via connecting rods or bowden cables or hydraulic cables. The operating means may be paddles, cranks, knobs or buttons. The operating unit may comprise a first and a second handle (pull-handle) or knob arranged adjacent to each other. Each may be interconnected to a pair of transfer rods, each pair of transfer rods being activatable independently from the other pair of transfer rods via the dedicated handle.

Each handle or knob may be interconnected to a first and a second reel, each of said first and second reel interacting with a ramp interconnected to a bolt. The handles or knobs may be spring loaded. If appropriate at least one of the locking units may be locked by a key. The thereto related means are preferably integrated into an operating unit.

A latch system according to the invention may be distributed as kit comprising an operating unit and at least one transfer unit each comprising transfer rods to transfer the movement of the operating unit to interconnected locking points. The transfer units may be made adjustable in length such that they can be easily adopted to several needs. The transfer units may be made bendable, such that the movement may be transferred around corners or other handicaps

### BRIEF DESCRIPTION OF THE DRAWINGS

The herein described invention will be more fully understood from the description of the embodiments given herein below and the accompanying drawings, which should not be considered limiting to the invention described in the appended claims.

FIG. 1 shows in a schematic manner a first embodiment of the invention;

FIG. 2 shows a second embodiment of the invention in a perspective manner;

FIG. 3 shows a third embodiment of the invention in a perspective manner;

FIG. 4 shows a fourth embodiment of the invention in a perspective manner;

FIG. 5 shows a fifth embodiment of the invention in a perspective manner;

FIG. 6 shows a sixth embodiment of the invention integrated into the interior of a door;

FIG. 7 shows an seventh embodiment of the invention in a perspective manner from the rear above;

FIG. 8 shows the seventh embodiment in a perspective manner from the rear and bellow;

FIG. 9 shows in a perspective manner the inside of the seventh embodiment from the front and above;

FIG. 10 shows a eight embodiment of the invention in a perspective manner;

FIG. 11 shows the inside of the eight embodiment according to FIG. 10;

FIG. 12 shows a ninth embodiment of the invention mounted inside a door;

FIG. 13 shows an tenth embodiment of the invention mounted inside a door.

### DETAILED DESCRIPTION OF PREFERRED EMBODIMENTS

A better understanding of the present invention may be obtained by the present detailed description, which, when examined in connection with the accompanying drawings sets forth preferred embodiments of the inventions described herein. It should be understood that corresponding elements in the various figures are generally identified with corresponding reference numbers.

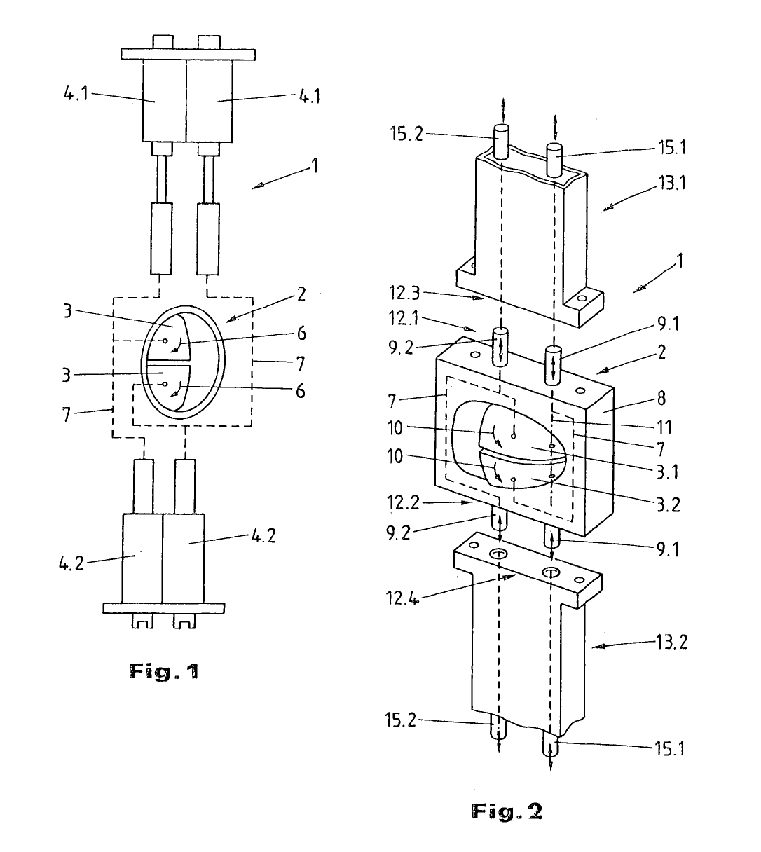

FIG. 1 shows a first embodiment of a multi-point latch system 1 in a schematic manner. The multi-point latch system comprises an operating unit 2. The operating unit 2 of the shown embodiment comprises two pull-handles 3 arranged adjacent to each other and independently operatable. The operating unit 2, respectively the pull-handles 3 are each functionally interconnected to two locking means 4.1, 4.2 arranged adjacent to each other. The locking means 4 defining locking points 5 are individually activatable by the pull-handles 3 in that they are pulled outwardly—indicated by first arrows 6—around an axis (not visible in detail). As indicated by dash-lines 7, each pull-handle is functionally interconnected to a first and a second locking means 4.1, 4.2 arranged adjacent to each other.

FIG. 2 shows a second embodiment multi-point latch system 1 having a modular setup in a perspective manner. The operating unit 2 comprises a housing 8. At the front of the housing 8 two handles 3.1, 3.2 are arranged by which a first and a second pair of bolts 9.1, 9.2 can be actuated: By pulling the handles 3.1, 3.2 outward (indicated by second arrows 10) around a rotation axis 11, the thereto connected first and second pair of bolts 9.1, 9.2 are moved inwardly or outwardly (the direction of movement is depending from the embodiment). The functional interconnection between the handles 3.1, 3.2 and the first and second pair of bolts 9.1, 9.2 is schematically indicated by dash-lines 7. The first and the second pair of bolts 9.1, 9.2 are forming in pairs part of a first and second interface 12.1, 12.2 foreseen to be interconnected by a third and a fourth interface 12.3, 12.4 of a first and a second transfer means 13.1, 13.2. The transfer means 13.1, 13.2 each comprise a housing 14 in which a first and a second transfer rod 15.1, 15.2 are arranged. In mounted position, when the interfaces 12.1, 12.2 of the operating unit 2 and the interfaces 12.3, 12.4 of the trans-fer means 13.1, 13.2 are interconnected to the transfer rods 15.1, 15.2, the movement of the first and the second handle 3.1, 3.2 is transferred via the first and the second pair of bolts 9.1, 9.2 to the first and second transfer rod 15.1, 15.2 of the first and the second transfer means 13.1, 13.2. If appropriate, the transfer means 13.1, 13.2 can have an angular shape e.g. to transfer the movement around a corner. The transfer means 13.1, 13.2 are transmitting the movement of the handles 3.1, 3.2 to a first and a second locking point (not shown in detail). The operating unit 2 may comprise inside the housing 8 a mechanism as shown and explained in connection with FIGS. 7 through 9.

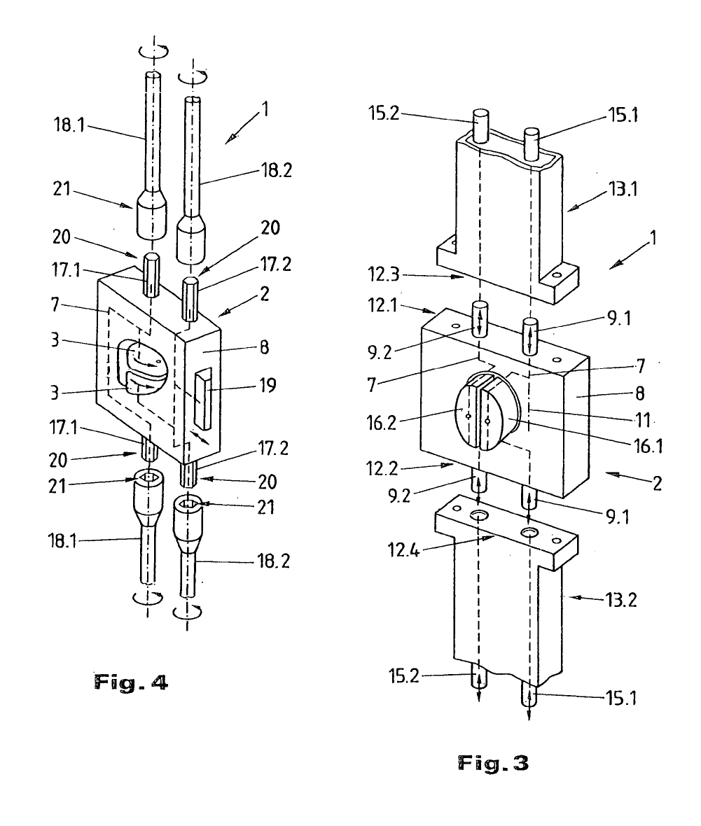

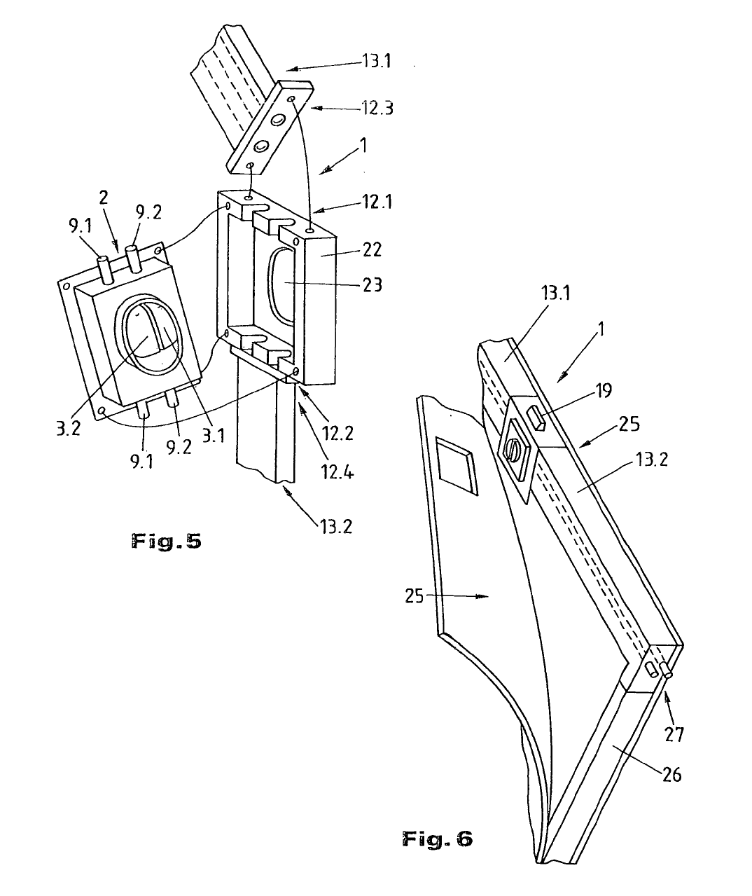

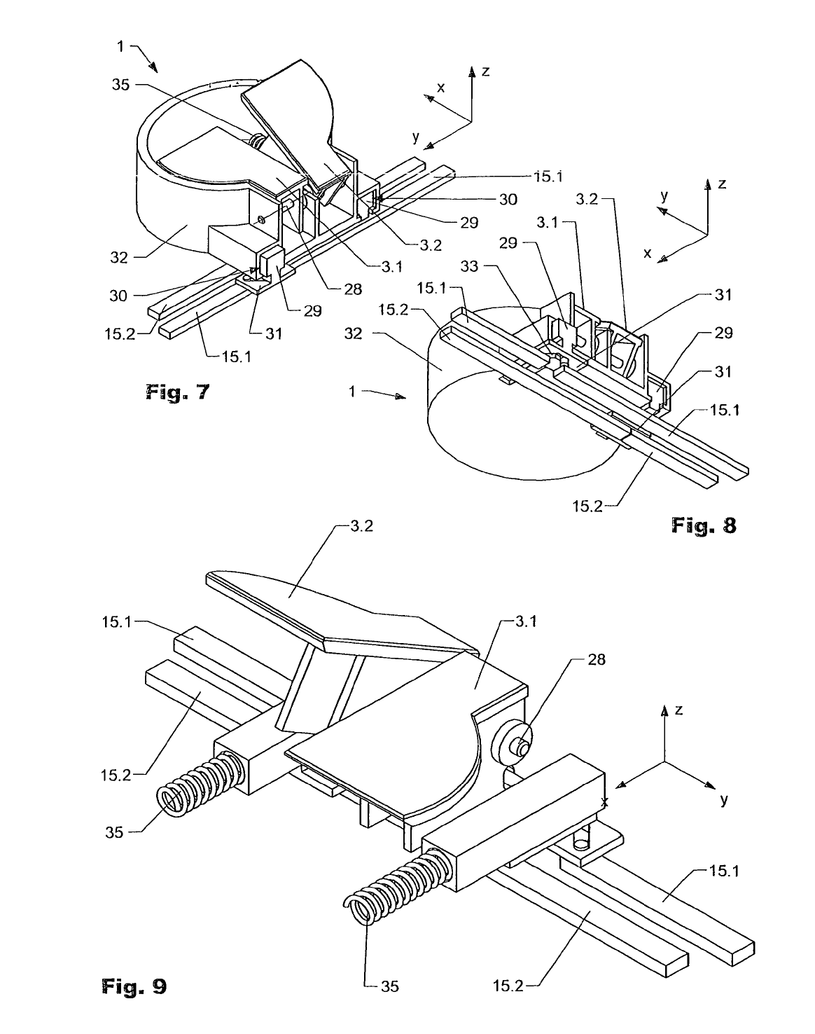

FIG. 3 in general corresponds to the embodiment according to FIG. 2. The operating unit 2 comprises a first and a second push-pull knobs 16.1, 16.2 to operate the device 2 instead of pull-handles. The principle functionality corresponds to the embodiments according to FIG. 2.

FIG. 4 shows a further embodiment of a multi-point latch system 1. The latch system 1 comprises an operating unit 2 with a housing 8 and with a two handles 3 functionally interconnected to a first and a second pair of actuating shafts 17.1, 17.2 protruding above the upper and the lower side surface of the housing 8. Other arrangements are possible. The functional interconnection is indicated by dash-lines 7. The shafts 17.1, 17.2 are foreseen to be interconnected to a first and a second transfer means here in the form of drive shafts 18.1, 18.2 which are functionally interconnected to the related actuating shafts 17.1, 17.2 via male and female drive couplings 20, 21. In the shown embodiment the function of the handles 3 is transferred in the form of rotation (indicated by third arrows 22). As it can be seen the lower handle 3 is in addition interconnected to a lateral latch 19 which acts as an additional locking means. If appropriate more then one lateral latch can be incorporated.

FIG. 5 is showing a further embodiment of a multi-point latch system 1 having a modular setup. The parts and operation in general correspond to the embodiment according to FIG. 1. Regarding the general function it is referred to this Figure. The latch system 1 comprises an operating unit 2 foreseen to be inserted into a cage 22. A first and a second trans-fer means 13.1, 13.2 can be interconnected via standardized interfaces 12.1, 12.2, to corresponding standardizes interfaces 12.3, 12.4 of the cage 22, respectively to the operating unit 2. The operating unit 2 is arranged removable, respectively exchangeable from the cage 22 and the other means. Thereby it can easily be repaired or replaced. The standardized interfaces 12.1, 12.2, 12.3, 12.4 are foreseen to position the parts of the latch system with respect to each other and to transfer the operating movements of the bolts 9.1, 9.2 to the transfer means 13.1, 13.2 and thereby to the locking points (not shown in detail). The operating unit 2 is inserted into the cage 22 from the back such that the handles 3.1, 3.2 extend across an front opening 23 such that they can easily be accessed and operated from the front.

FIG. 6 is showing a latch system 1 in a mounted position incorporated into a face side 24 and the outer frame 26 of a door 25. The top layer of the door is partially lifted off to allow access at the inside. The latch system 1 here comprises an operating unit 2 with a lateral latch 19. The lateral latch 19 can be avoided, e.g. when the latch system 1 is not mounted immediately adjacent to the face side 24 of the door 25. In the shown embodiment a lower locking point 27 can be seen which is interconnected via the lower transfer means 13.2 to the operating unit 2. An upper locking point (not shown in detail) is interconnected in corresponding manner. If appropriate the locking points may be directly integrated into operating unit 2.

FIG. 7 is showing a further embodiment of a latch system 1 in a perspective manner from rear and above. FIG. 8 is showing the latch system according to FIG. 7 in a perspective manner from rear and bellow. FIG. 9 is showing the inside of the latch system 1 in a perspective manner from the front and above. The latch system 1 comprises a first and a second handle 3.1, 3.2 which are liftable (pivotable) around a rotation axis 28 (y-axis). For a better understanding the second handle 3.2 is shown in a lifted manner. The handles 3.1, 3.2 are each interconnected to a bolt 29 arranged in and displaceable (in x-direction) along a channel 30. The bolts 29 comprise a guiding plate 31 projecting above the lower part of a housing 32. The guiding plates 31 each comprise a (V-shaped) guiding slot 33 which is serves as a guiding means for a first and a second transfer rod 15.1, 15.2. The transfer rods 15.1, 15.2 are arranged displaceable in y-direction only while the other degrees of freedom are locked. They are interconnected to the guiding plates 31 via a guiding pin 34 which is engaged with the guiding slot 33. By lifting the handles 3.1, 3.2 (see second handle 3.2) upwardly tilting backwardly around axis 28 the thereto interconnected bolt 29 and the guiding plate 31 and the guiding slot 33 are displaced against the force of a spring 35 in +x-direction. Thereby the pairs of the first and the second transfer rods 15.1, 15.2 are pulled together in y-direction (see pair of second transfer rods 15.2 in FIG. 8).

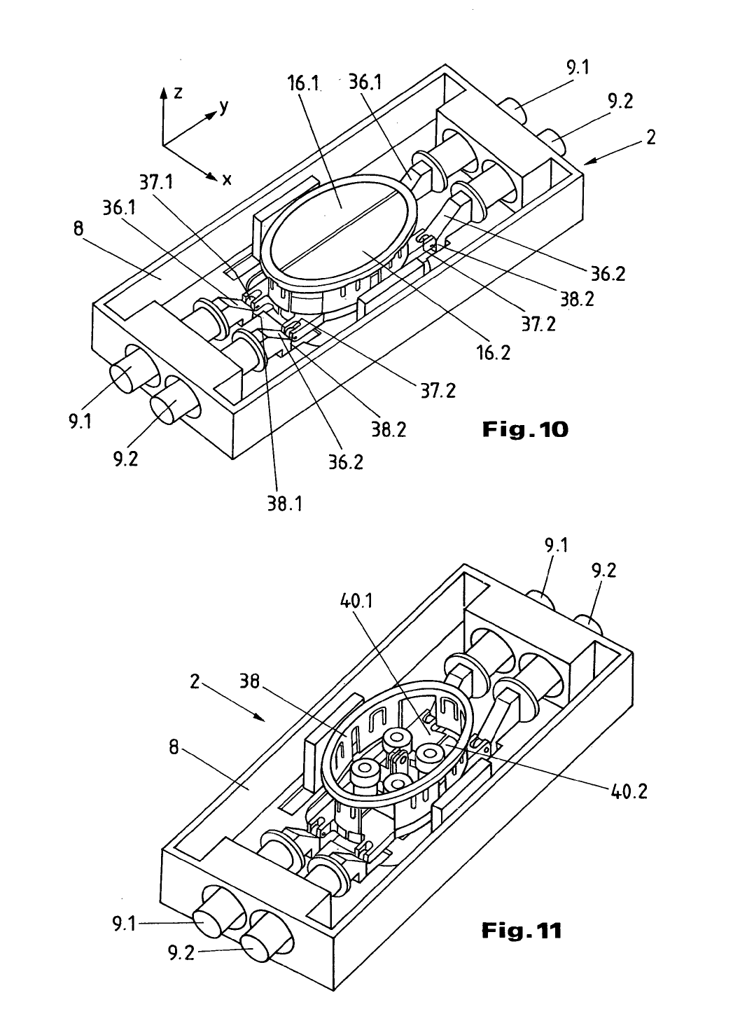

FIG. 10 and FIG. 11 are showing a further embodiment of a operating unit 2 in a perspective manner. In FIG. 11 the push-pull knobs 16.1, 16.2 are removed such that the inside is better visible. The operating unit 2 comprises a housing 8 in which first and the second pair of bolts 9.1, 9.2 are arranged displaceable in y-direction. The bolts 9.1, 9.2 carry on their inner ends ramps 36.1, 36.2 which interact with reels 37.1, 37.2 interconnected to the knobs 16.1, 16.2. The knobs 16.1, 16.2 and the reels 37.1, 37.2 are arranged displaceable in z-direction. By pressing down the knobs 16.1, 16.2 the reels 37.1, 37.2 act interact with the ramps 36.1, 36.2 pressing the rods 15.1, 15.2 outwardly. In the shown drawing the rods 15.1, 15.2 are in their outward position. In the shown embodiment the ramps 36.1, 36.2 each lead into vertical section 38.1, 38.2. In locked position the reels 37.1, 37.2 have reached the vertical sections avoiding 38.1, 38.2 unwanted unlocking. The lock can be released by moving the knobs 16.1, 16.2 outwardly. As it can be seen in FIG. 11, the knobs 16.1, 16.2 are arranged inside a guiding means 38. The knobs 16.1, 16.2 may be spring loaded against springs. One advantage of the embodiments shown here is the low profile design and the simple set-up. The low profile design allows the incorporation of the mechanism in relatively thin panels. A further advantage is the modular setup allowing easy exchange and repair availability. The reels 37.1, 37.2 are arranged at a first and a second inner guiding frame 40.1, 40.2 which is movable in vertical direction (z-direction). The guiding frames carry on opposite ends a reel 37.1, 37.2. The centre area of the guiding frames 40.1, 40.2 is foreseen to interact with the knobs 16.1, 16.2.

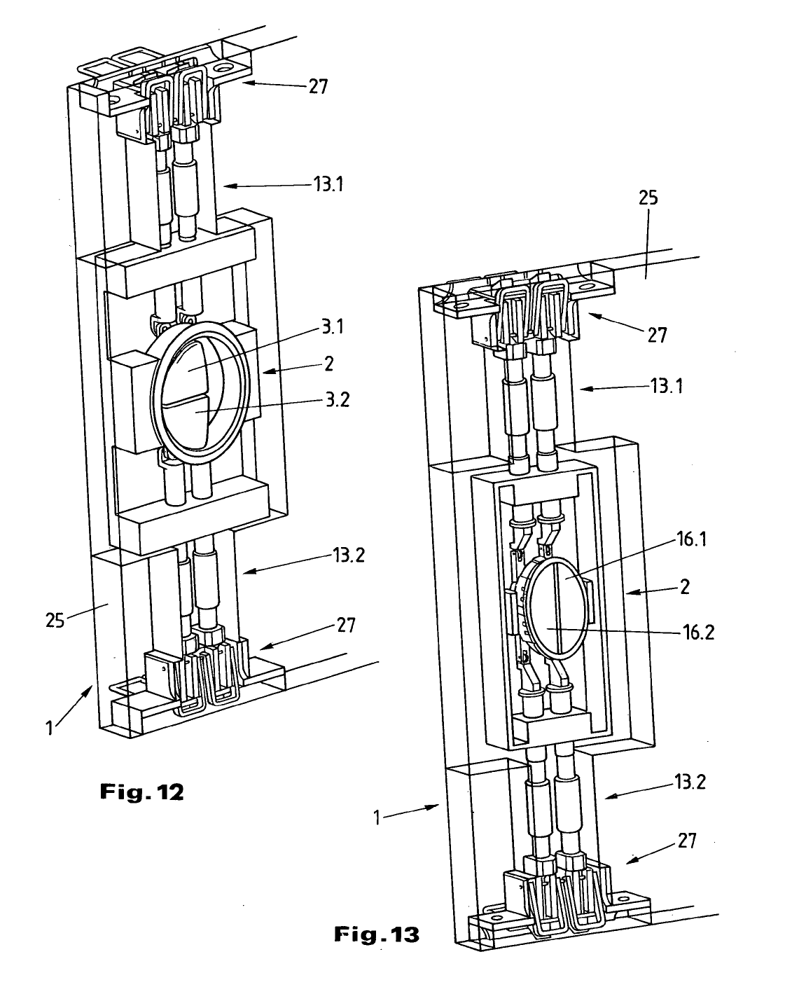

FIGS. 12 and 13 are showing a first and a second embodiment of a modular latch system 1 incorporated into a door 25. As it can be seen the operating units 2 and the transfer means 13.1, 13.2 of the latch systems 1 are completely integrated into the door 25. The only parts which are visible from the outside are the upper and the lower locking points 27 and the handles 3, 16. The operating unit 2 and the transfer means 13.1, 13.2 are interconnected via standardized interfaces.

### LIST OF REFERENCE SIGNS

| | |
|---|---|
| 1 | Multi-point latch system |
| 2 | Operating unit |
| 3.1 | First pull-handle (operating means) |
| 3.2 | Second pull-handle (operating means) |
| 4.1 | Locking means (locking unit) |
| 4.2 | Locking means (locking unit) |
| 5 | Locking points |
| 6 | First arrows (pull direction) |
| 7 | Dash-lines |
| 8 | Housing |
| 9.1 | First pair of bolts |
| 9.2 | Second pair of bolts |
| 10 | Second arrows (pull direction) |
| 11 | Rotation axis |
| 12.1 | First interface |
| 12.2 | Second interface |
| 12.3 | Third interface |
| 12.4 | Fourth interface |
| 13.1 | First transfer means (locking unit) |
| 13.2 | Second transfer means (locking unit) |
| 14 | Housing |
| 15.1 | First transfer rod (connecting rod) |
| 15.2 | Second transfer rod (connecting rod) |
| 16.1 | First push-pull knob |
| 16.2 | Second push-pull knob |
| 17.1 | First actuating shaft |
| 17.2 | Second actuating shaft |
| 18.1 | First transfer means |
| 18.2 | Second transfer means |
| 19 | Lateral latch |
| 20 | Male drive coupling |
| 21 | Female drive coupling |
| 22 | Cage |
| 23 | Front opening |
| 24 | Face side |
| 25 | Door |
| 26 | Outer frame |
| 27 | Locking point |
| 28 | Rotation axis |
| 29 | Bolt |
| 30 | Channel |
| 31 | Guiding plate |
| 32 | Housing |
| 33 | Guiding slot |
| 34 | Guiding pin |
| 35 | Spring |
| 36 | Ramp |
| 37 | Reel |
| 38 | Guiding means |

1. A multi-point latch system comprising:
an operating unit comprising at least two independently operatable operating means and at least two locking means arranged adjacent to each other each interconnected to one of said operating means, said locking means defining locking points individually activatable by said operating means.

2. The multi-point latch system according to claim 1, wherein the operating unit and the locking means each comprise a housing designed to be integrated into the inside of a door.

3. The multi-point latch system according to claim 1, wherein the housing of the operating unit and the housing of the locking unit comprise standardized interfaces, compatible to each other to interconnect the operating unit and the locking unit.

4. The multi-point latch system according to claim 1, wherein a locking unit comprises two connecting rods arranged adjacent to each other, each connecting rod actuating an individual locking point.

5. The multi-point latch system according to claim 1, wherein the operating unit and the locking unit are interconnected via connecting rods or drive shafts or bowden cables or hydraulic cables.

6. The multi-point latch system according to claim 1, wherein the operating means are paddles, cranks, knobs or buttons.

7. The multi-point latch system according to claim 1, wherein the operating unit comprises a first and a second handle or knob arranged adjacent to each other and each interconnected to a pair of transfer means, each transfer means being activatable independently from the other transfer means via the dedicated handle.

8. The multi-point latch system according to claim 7, wherein the each handle or knob is interconnected to a first and a second reel, each of said first and second reel interacting with a ramp interconnected to a bolt.

9. The multi-point latch system according to claim 7, wherein each handle or knob is spring loaded.
